(19) United States
(12) Patent Application Publication
(10) Pub. No.: US 2009/0178469 A1
(43) Pub. Date: Jul. 16, 2009

(54) WATERPROOFING TEST SYSTEM FOR TESTING WATERPROOFING OF AN OBJECT AND METHOD THEREOF

(76) Inventor: Tien-Chung Tseng, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/168,166

(22) Filed: Jul. 7, 2008

(30) Foreign Application Priority Data
Jan. 11, 2008 (TW) 097101162

(51) Int. Cl. G01M 3/04

(52) U.S. Cl. 73/45.5

(57) ABSTRACT

A waterproofing test system for testing waterproofing of an object includes a container for containing fluid. The object is disposed with the fluid inside the container. The waterproofing test system includes a pressure part for applying pressure to the fluid so that the pressure of the fluid can reach to a simulation pressure.

### BACKGROUND OF THE INVENTION

1. Field of the Invention

The present invention relates to a waterproofing test system for testing waterproofing of an object and method thereof, and more particularly, to a waterproofing test system capable of applying pressure to fluid especially so as to reach to a simulation pressure for testing waterproofing of an object and method thereof.

2. Description of the Prior Art

The waterproofing function, dust-proof function, electrostatic discharge (ESD) protection, and so on, for increasing service life, safety, and stability of electronic devices are important nowadays. For example, it is important to prevent damage of the electronic device due to utilization in moist condition or falling into water resulting in a short circuit of the electronic device.

Please refer to FIG. 1. FIG. 1 is a diagram of a waterproofing test system 10 in the prior art. Typically, the waterproofing test system 10 includes a tube 12 for containing fluid 14, such as water. An object 16 is disposed in the fluid 14 inside the tube 12. A weight 18 is tied to the object 16 so that the object 16 sinks to a bottom of the tube 12 for reaching to a simulation pressure applied to the object 16 conforming to standard of the waterproofing test. The pressure applied to the object 16 increases with a distance between the object 16 and a surface of the fluid 14. The pressure applied to the object 16 is equal to the sum of atmospheric pressure and the pressure of the fluid 14, and the pressure of the fluid 14 is the product of the depth of the object 14 in the fluid 14 and the density of the fluid 14. For reaching to the simulation pressure applied to the object 16 conforming to standard of the waterproofing test, there is a need to increase the depth of the object 14 in the fluid 14, especially for the water, so that the tube 12 with a long dimension is needed. It is difficult to store the tube 12 with the long dimension. In addition, there is limitation and risk to operate the tube 12 with the long dimension. For example, the string connected to the object 14 and the weight 18 might break, and the number and speed of the waterproofing test are limited.

### SUMMARY OF THE INVENTION

It is therefore a primary objective of the invention to provide a waterproofing test system capable of applying pressure to fluid especially so as to reach to a simulation pressure for testing waterproofing of an object and method thereof for solving the above-mentioned problem.

According to the claimed invention, a waterproofing test system for testing waterproofing of an object includes a container for containing fluid. The object is disposed in the fluid inside the container. The waterproofing test system further includes a pressure part for pressing the fluid inside the container so as to increase pressure of the fluid.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a waterproofing test system in the prior art.

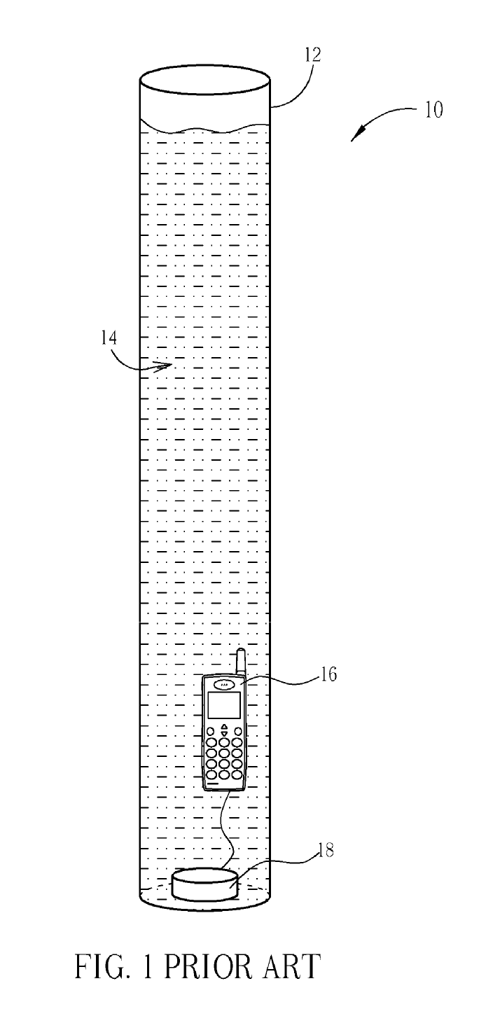

FIG. 2 is a diagram of a waterproofing test system according to a preferred embodiment of the present invention.

FIG. 3 is a flowchart illustrating that the waterproofing test system tests waterproofing degree of an object according to the preferred embodiment of the present invention.

### DETAILED DESCRIPTION

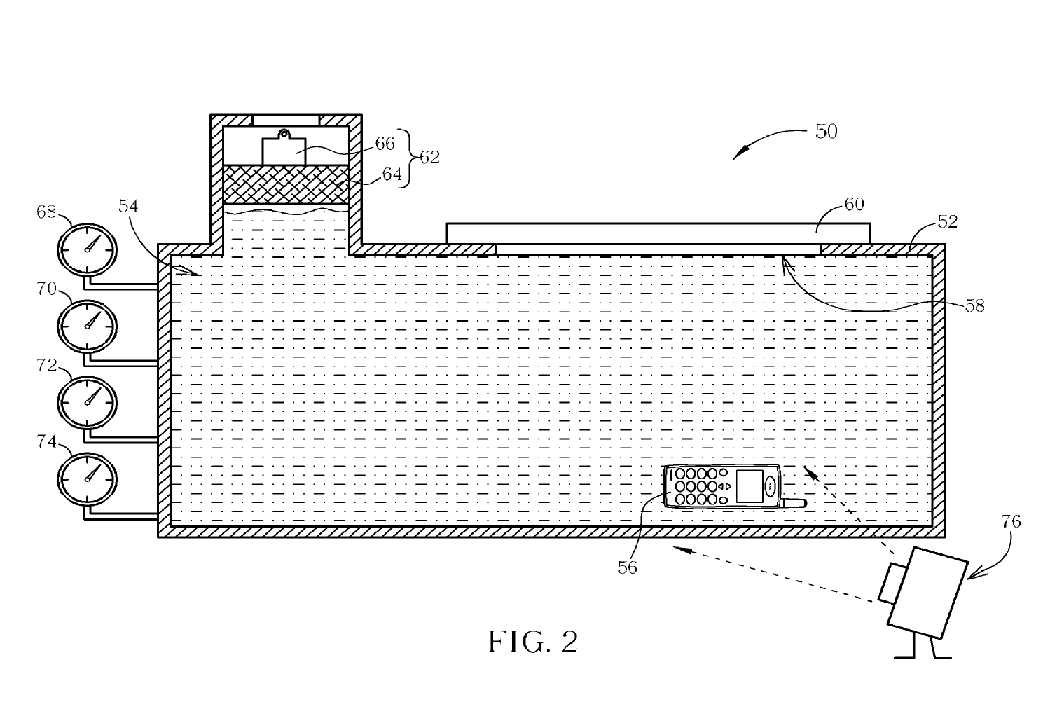

Please refer to FIG. 2. FIG. 2 is a diagram of a waterproofing test system 50 according to a preferred embodiment of the present invention. The waterproofing test system 50 includes a container 52 for containing fluid 54, such as water. An object 56 is disposed in the fluid 54 inside the container 52. The object 56 can be an electronic device, such as a mobile phone. An opening 58 is formed on the container 52. The waterproofing test system 50 further includes a cover 60 for covering the opening 58. The object 56 can be put inside the container 52 through the opening 58, and the opening 58 is covered by the cover 60 so that the waterproofing test system 50 is a close test system. The waterproofing test system 50 further includes a pressure part 62 for pressing the fluid 54 inside the container 52 so as to increase pressure of the fluid 54 until the pressure of the fluid 54 reaches to a simulation pressure. In this embodiment, the pressure part 62 includes a piston 64. and a weight 66 for pressing the piston 64 so as to apply pressure to the fluid 54. The weight 66 can be a counterweight. The pressure part 62 also can be other means for applying pressure to the fluid 54, such as a pneumatic device, a hydraulic device, an elastic pressure device, and so on.

In addition, the waterproofing test system 50 further includes a manometer 68 for measuring and displaying the pressure of the fluid 54, a timer 70 for displaying time, a thermometer 72 for measuring temperature of the fluid 54, a hydrometer 74 for measuring a specific gravity of the fluid 54, and an image-capturing device 76 for capturing an image of the object 56 disposed in the fluid 54 inside the container 52. The image-capturing device 76 can be a camera for recording the test process of the object 56 as reference for determining waterproofing degree of the object 56.

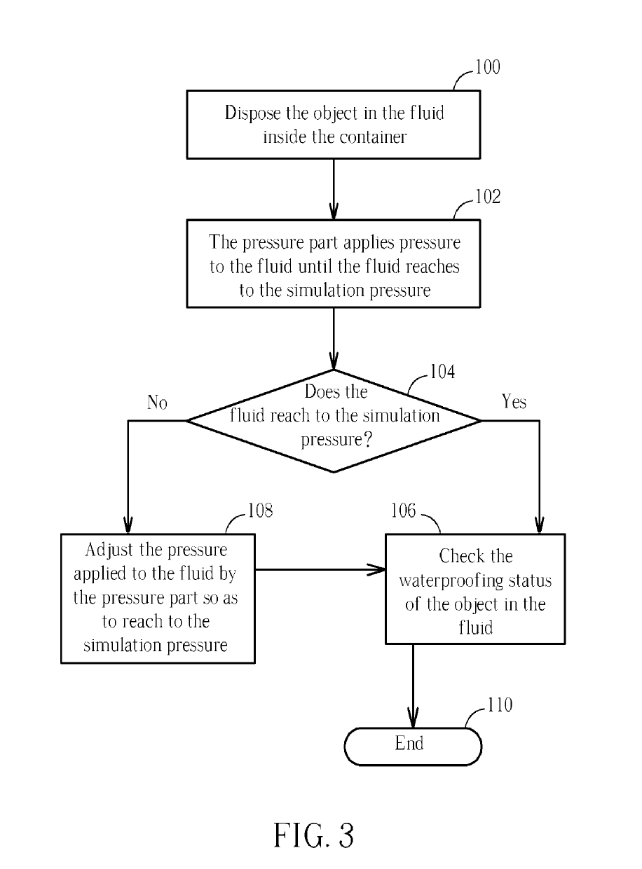

Please refer to FIG. 3. FIG. 3 is a flowchart illustrating that the waterproofing test system 50 tests waterproofing degree of the object 56 according to the preferred embodiment of the present invention. The method includes:

Step 100: Dispose the object 56 in the fluid 54 inside the container 52.

Step 102: The pressure part 62 applies pressure to the fluid 54 until the fluid 54 reaches to the simulation pressure.

Step 104: Check whether the fluid 54 reaches to the simulation pressure by the manometer 68. If the fluid 54 reaches to the simulation pressure, go to step 106; if not, go to step 108.

Step 106: Check the waterproofing status of the object 54 in the fluid 54.

Step 108: Adjust the pressure applied to the fluid 54 by the pressure part 62 so as to reach to the simulation pressure.

Step 110: End.

The user can correct the manometer 68, the timer 70, the thermometer 72, and the hydrometer 74 firstly. The user opens the cover 60 on the opening 58 and pours the fluid 54 in the container 52. The object 56 can be put in the fluid 54 inside the container 52 via the opening 58. Then the cover 60 covers the opening 58 tightly so that the waterproofing test system 50 is a close test system. The pressure part 62 can press the fluid 54 so that the pressure of the fluid 54 reaches to the simulation pressure. The user can check whether the pressure of the fluid 54 reaches to the simulation pressure according to the pressure of the fluid 54 measured by the manometer 68. Simultaneously, the user can check whether the time that the object 56 is disposed in the fluid 54 measured by the timer 70, the temperature of the fluid 54 measured by the thermometer 72, the specific gravity of the fluid 54 measured by the hydrometer 74 conform to standard of the waterproofing test. Furthermore, the image-capturing device 76 can be utilized for capturing images of the object 56 in the fluid 54, such as recording the test process of the object 56 as reference for determining whether the fluid 54 penetrates through the object 56 during the test process. The timer 70 can alert the user with a ring when reaching to the end of the test process.

During the test process, the user can properly adjust the pressure applied to the fluid 54 by the pressure part 62 so that the pressure of the fluid 54 can reach to the simulation pressure conforming to standard of the waterproofing test. When the manometer 68 shows that the measured pressure of the fluid 54 reaches to the simulation pressure, it means there is an equivalent effect of the pressure applied to the fluid 54 by the pressure part 62 and the pressure of the object 56 disposed to a corresponding depth in the fluid 54.

In conclusion, the present invention utilizes the pressure part 62 to press the fluid 54 especially for reaching the pressure conforming to standard of the waterproofing test so that there is no need to dispose the object 56 to the enough depth. It has advantages of reducing the size of the test container, simply structure of the container, storing the container easily, no limitation and risk to operate the container, no need to use the string connected to the object, and increasing the number and speed of the waterproofing test.

In contrast to the prior art, the waterproofing test system and related method of the present invention presses the fluid especially for reaching the pressure conforming to standard of the waterproofing test so that the size of the fixture can be reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A waterproofing test system for testing waterproofing of an object comprising:
a container for containing fluid, the object being disposed in the fluid inside the container; and
a pressure part for pressing the fluid inside the container so as to increase pressure of the fluid.

2. The waterproofing test system of claim 1 further comprising a manometer for measuring and displaying the pressure of the fluid.

3. The waterproofing test system of claim 1 further comprising a timer for displaying time.

4. The waterproofing test system of claim 1 further comprising a thermometer for measuring temperature of the fluid.

5. The waterproofing test system of claim 1 further comprising a hydrometer for measuring a specific gravity of the fluid.

6. The waterproofing test system of claim 1 further comprising an image-capturing device for capturing an image of the object disposed in the fluid inside the container.

7. The waterproofing test system of claim 1 wherein an opening is formed on the container and the waterproofing test system further comprises a cover for covering the opening.

8. The waterproofing test system of claim 1 wherein the pressure part comprises a piston, and a weight for pressing the piston.

9. The waterproofing test system of claim 8 wherein the weight is a counterweight.

10. The waterproofing test system of claim 1 wherein the pressure part comprises a pneumatic device, a hydraulic device, or an elastic pressure device.

11. The waterproofing test system of claim 1 wherein the fluid is water.

12. The waterproofing test system of claim 1 wherein the object is an electronic device.

13. A method for testing waterproofing of an object comprising: disposing the object in fluid; and
pressing the fluid so as to increase pressure of the fluid.

14. The method of claim 13 further comprising examining waterproofing situation of the object in the fluid.

15. The method of claim 13 further comprising utilizing a manometer to detect whether the pressure of the fluid reaches to a simulation pressure.

16. The method of claim 13 further comprising measuring duration of disposing the object in the fluid.

17. The method of claim 13 further comprising measuring temperature of the fluid.

18. The method of claim 13 further comprising measuring a specific gravity of the fluid.

19. The method of claim 13 further comprising capturing an image of the object in the fluid.
